(19) United States
(12) Patent Application Publication
(10) Pub. No.: US 2014/0270091 A1
(43) Pub. Date: Sep. 18, 2014

(54) ROTATING DRUM COLLIMATOR

(71) Applicants: Lee L. NEMETH, Prospect, CT (US); Arthur RADOMSKI, Bristol, CT (US)

(72) Inventors: Lee L. NEMETH, Prospect, CT (US); Arthur RADOMSKI, Bristol, CT (US)

(21) Appl. No.: 14/199,007

(22) Filed: Mar. 6, 2014

Related U.S. Application Data
(60) Provisional application No. 61/784,481, filed on Mar. 14, 2013.

(51) Int. Cl. G21K 1/04

(52) U.S. Cl. CPC G21K 1/04
USPC 378/150

(57) ABSTRACT

Exemplary embodiments of the present invention are directed to a rotating drum collimator for collimating an energy beam to produce a scanning beam that includes a drum having a substantially cylindrical sidewall with a first helical groove and a second helical groove formed in the cylindrical side wall, and a motor operatively connected to the drum, and configured to cause rotation of the drum about a longitudinal axis of the drum. Each of the first helical groove and the second helical groove comprises a first end portion, a middle portion and a second end portion, and a width of the first end portion and the second end portion of each of the first helical groove and the second helical groove is greater than the middle portion of each of the first helical groove and the second helical groove.

### CROSS-REFERENCE TO RELATED APPLICATIONS

This application claims priority to U.S. Provisional Appl. No. 61/784,481 filed Mar. 14, 2013, which is hereby incorporated by reference in its entirety.

### BACKGROUND OF THE INVENTION

1. Field of the Invention

The present invention is directed to rotating drum collimators, and more particularly to rotating drum collimators that provide for control of a beam along degrees of an arc by manipulating the angular motion of the beam and/or control of the scanning frequency of the beam.

2. Description of Related Art

Current collimator designs use a large diameter chopping wheel that has a large mass, and produces a great amount of inertia. These current collimators require a large amount of space and a great deal of shielding to prevent the energy from scattering towards unwanted objects and/or personnel. In addition, the large size makes the collimator units extremely heavy and requires a great amount of construction to handle the large pieces and heavy weight of the components. The heavy weight of the large diameter wheels and drums prevents the system from quick changes in scanning frequency which would increase through put at screening stations, such as at border stations and/or airports. Therefore, what is needed is a device to allows for less time to be needed in order to change the scanning frequency in response to the desired object and/or person to be scanned.

Furthermore, other drum collimators, such as shown in U.S. Pat. No. 4,745,631, which is hereby incorporated by reference in its entirety, are limited in that the collimated beam may be projected and/or moved only in a linear direction. See also U.S. Pat. No. 6,272,206, which is hereby incorporated by reference in its entirety. In addition, as discussed in U.S. Appl. Publ. No. 2011/0293072, which is hereby incorporated by reference in its entirety, and U.S. Appl. Publ. No. 2012/0288066, which is hereby incorporated by reference in its entirety, it is understood that beam scanning devices may have a variety of uses and/or applications. Therefore, may be desirable to provide a device that is not limited in the direction and/or orientation in which a scanning beam may be projected and/or moved.

### SUMMARY OF THE INVENTION

The present invention is designed to overcome the above noted limitations that are attendant upon the use of conventional collimators and, toward this end, it contemplates the provision of a novel rotating drum collimator that allows for efficient changes in scanning frequency of a scanning beam and/or control of a scanning beam along the degrees of an arc by manipulating the angular motion of the beam while providing a controlled and/or desirable cross-section of the scanning beam.

Accordingly, it is an object of the present invention to provide a collimator that includes a drum that rotates within a housing that has two inline slots machined, formed and/or cut into it.

It is another object of the present invention to provide a collimator that is configured to control a beam, for example a stream of X-rays or other type of radiation, along the degrees of an arc.

It is still another object of the present invention to provide a collimator that is configured to manipulate a beam by providing for angular motion of the beam.

It is yet another object of the present invention to provide a collimator that is configured to interrupt and/or break a beam, for example a stream of X-rays or other type of radiation, in order to allow for frequency manipulation of the beam.

It is still another object of the present invention to provide for angular projection of a beam, for example a stream of X-rays or other type of radiation, while maintaining a consistent cross-section of the beam as the beam moves along a plane, e.g. horizontal or vertical.

It is yet another object of the present invention to provide a collimator that is configured to produce a scanning beam of energy, and provide for rapid changes in the frequency of the scanning beam of energy depending upon the object to be scanned.

It is still another object of the present invention to provide a collimator that may include aperture holes and is positioned to spin around an X-ray generator or other energy producing device.

In accordance with at least some of these objects of the present invention, an exemplary embodiment of the present invention may be directed to a rotating drum collimator that includes an energy generating source having an opening for energy produced from the energy generating source to extend outwardly from, a first collimator having a plurality of channels formed in a fan-shaped pattern and positioned around the opening of the energy generating source, a drum slotted collimator operatively connected to a motor which is configured to cause rotation of the drum slotted collimator about a longitudinal axis of the drum collimator, and a second collimator positioned on an opposite side of the drum slotted collimator from the first collimator and having a plurality of channels formed in a fan-shaped pattern.

In accordance with this exemplary embodiment of the present invention, the drum slotted collimator may include a pair of helical grooves in a cylindrical sidewall of the drum slotted collimator, where each of the grooves has a width at the center of the grooves that is less than the width of the grooves at the ends.

In accordance with this exemplary embodiment of the present invention, the rotating drum collimator is configured to produce a scanning beam from the energy produced from the energy generating source.

In accordance with this exemplary embodiment of the present invention, the rotating drum collimator is configured to manipulate the scanning beam to produce angular motion of the scanning beam.

In accordance with this exemplary embodiment of the present invention, the rotating drum collimator is configured to produce the scanning beam of at least at two different frequencies.

### BRIEF DESCRIPTION OF THE SEVERAL VIEWS OF THE DRAWINGS

For a fuller understanding of the nature and objects of the present invention, reference is made to the following detailed description taken in connection with the accompanying drawings in which:

FIG. 1 is a side perspective view of an exemplary rotating drum collimator according to the present invention;

FIG. 2 is a rear view of the exemplary rotating drum collimator according to the present invention;

FIG. 3 is a cross-sectional view of the exemplary rotating drum collimator taken along line 3-3 in FIG. 2 according to the present invention;

FIG. 3A is a cross-sectional view of the exemplary rotating drum collimator taken along line 3-3 in FIG. 2 according to the present invention;

FIG. 4A is a side view of an exemplary drum/rotating slotted wheel that may be used in the rotating drum collimator according to the present invention;

FIG. 4B is a top plan view of the exemplary drum/rotating slotted wheel that may be used in the rotating drum collimator according to the present invention;

FIG. 4C is a front view of the exemplary drum/rotating slotted wheel that may be used in the rotating drum collimator according to the present invention;

FIG. 5 is a two-dimensional view of an exemplary groove that may be cut into the drum/rotating slotted wheel according to the present invention;

FIG. 6 is a rear perspective view of another exemplary rotating drum collimator according to the present invention; and

FIG. 7 is a side view of an exemplary drum assembly that may be used with the rotating drum collimator according to the present invention.

### DETAILED DESCRIPTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

Referring now to FIGS. 1-3, 3A and 6, therein illustrated is an exemplary embodiment of a rotating drum collimator according to the present invention, generally indicated by reference numeral 10. The rotating drum collimator 10 may include an energy generator 20, for example an X-ray generator, which is configured to generate energy from a particular energy source 22. It is understood that the energy generator 20 may be capable of producing the energy from the energy source 22, or merely a housing for the energy source 22 and configured to direct the energy from the energy source 22 in a desired direction, and that the present invention is not limited to any particular configuration of the energy generator 20. It is further understood that the energy be of any known energy, for example a stream of electrons, as understood by one of skill in the art, and that reference to an X-ray generator is merely exemplary and not limited to the present invention in any manner. The energy generator 20 may, for example, be configured to produce any form of ionizing or non-ionizing radiation. The rotating drum collimator 10 may also include a rear collimator 25 attached to the energy generator 20 and extending from and around an opening 27 formed in the energy generator 20. The rear collimator 25 may extend from the energy generator 20, and have an opening 29 spaced away from the opening 27 of the energy generator 20 that is configured to provide a passage for energy generated by the energy source 22 within the energy generator 20 to travel from the energy source 22 to a housing 31 (FIG. 6) connected to the rear collimator 25. It is understood that the housing 31 is removed from the views shown in FIGS. 1-3 and 3A in order to facilitate illustration of the exemplary embodiment of the invention.

Referring particularly to FIGS. 3 and 3A, the rear collimator 25 may also include a plurality of fan shaped channels 33 that are configured to collimate the energy generated by the energy generator 20. Each of the fan shaped channels 33 extends from the opening 27 of the energy generator 20 to the opening 29 of the rear collimator 25. Each of the fan shaped channels 33 may have the same cross-sectional shape so that a beam of the energy from the energy generator 20 leaving the rear collimator 25 from the opening 29 has substantially the same shape regardless of the fan shape channel 33 that the beam of energy passes through. The fan shaped channels 33 may be oriented within the rear collimator 25 relative to the energy generator 20 so that each of the fan shaped channels 33 is positioned substantially normal to the opening 27 in the energy generator 20. In this manner, the fan shaped channels 33 may be positioned around the degrees of an arc formed by the opening 27 of the energy generator 20 so that the fan shaped channels 33 extend from the energy generator 20 through the rear collimator 25 in a substantially fan-shaped pattern. However, it is understood that such configuration is merely exemplary, and that the present invention is not limited to any particular configuration of the fan shaped channels 33. It is further understood that each of the fan shaped channels 33 may be narrower at a position closer to the energy generator 20 then the fan shaped channel 33 is at a position farther away from the energy generator 20. In this manner, the width of the beam of energy entering any particular fan shaped channel 33 may increase as the beam of energy travels farther from the energy generator 20.

Referring now to FIGS. 1-3 and 3A, the rotating drum collimator 10 may also include a drum 35 that is attached to a motor 37, for example a variable speed motor, by a drive shaft 39. A coupling 41 may be provided between the motor 37 and the drive shaft 39. The motor 37 is configured to rotate the drum 35 at the desired speed in order to produce a scanning beam from the beam of energy transmitted from the energy generator 20.

Referring now to FIGS. 4A, 4B and 4C, the exemplary drum 35 that may be used in the rotating drum collimator 10 according to the present invention is shown. The drum 35 may be formed from a substantially cylindrical body having a hollow interior region. The drum 35 may also include a first groove 45 and a second groove 47 that have been cut, formed and/or machined into the cylindrical body of the drum 35. The first groove 45 and the second groove 47 may extend helically from a first end of the cylindrical body of the drum 35 longitudinally to a second end of the cylindrical body of the drum 35. Since the drum 35 has a cylindrical body with a hollow interior, when an intersection of the first groove 45 and the second groove 47 is formed along a longitudinal plane of the drum 35 an iris 49 is formed. The iris 49 provides for an opening for the beam of energy transmitted from the energy generator 20 to pass through the drum 35. The iris 49 may also act to collimate the beam of energy in order to shape and/or direct the beam of energy in the desired manner. As the drum rotates about its longitudinal axis 51, the iris 49 will travel along the longitudinal axis 51 of the drum 35 towards either the first end or the second end of the drum 35 depending upon the direction of rotation of the drum 35 about its longitudinal axis 51.

Referring now to FIGS. 4A, 4B, 4C and 5, each of the first groove 45 and the second groove 47 have a middle portion 53 and a pair of end portions 55. The first groove 45 and the second groove 47 may have a shape that tapers outward from the middle portion 53 of the grooves 45, 47 towards the end portions 55 of the grooves 45, 47, so that the width of the grooves 45, 47 at the middle portion 53 of the grooves 45, 47 is less than the width of the grooves 45, 47 at the end portions 55 of the grooves 45, 47.

For example, the ratio of the width of one or more of the grooves 45, 47 its middle portion 53 to the width of the grooves 45, 47 at its one or more of the end portions 55 may be 1:x, where x is greater than one. As a result of this configuration of the grooves 45, 47, the beam of energy transmitted from the energy generator 20 may extend angularly from the ends of the drum 35 along the degrees of an arc extending from the drum 35. This configuration of the grooves 45, 47 allows for manipulation of the beam of energy to provide for angular motion of the beam of energy. While the grooves 45, 47 are shown having rounded end portions 55, it is understood that the end portions 55 of the grooves 45, 47 may have any desirable shape and/or configuration for collimating the beam of energy, and such shape and/or configuration may for example be flat or pointed.

As shown for example in FIG. 5, the grooves 45, 47 may taper out to have a larger width at the end portions 55 than in the middle portion 53. It is understood that the grooves 45, 47 may have a consistent taper to increase the width of the grooves 45, 47 from the middle portion 53 to the end portions 55, or the increase in width of the grooves 45, 47 may vary along the length of the grooves 45, 47 from the middle portion 53 to the end portions 55, or have a step-wise increase of width along the length of the grooves 45, 47. It is further understood that each of the grooves 45, 47 may have the same ratio of width at the middle portions 53 to the ends portions 55 of the respective grooves 45, 47 or the ratio may differ between the grooves 45, 47. FIG. 5 shows the groove in a plan view in order to clearly show the increase in the width of the grooves from the middle portion 53 to the end portion 55. It is understood that the ratio of the width of one end portion 55 to the middle portion 53 may be different than the ratio of the width of the other end portion 55 to the middle portion 53.

It is understood that while the ends of the grooves 45, 47 may overlap, it may be desirable to position the grooves 45, 47 along the drum 35 so that only one end of the first groove 45 overlaps with one end of the second groove 47 overlap at a time instant. In this manner, only one iris 49 would be formed for the beam of energy transmitted from the energy source 20 to pass through the drum 35 at particular time instant. For example, the grooves 45, 47 may be positioned on the drum 35 so that one of the grooves 45, 47 extends helically around the drum 35 from about 0° to about 180°, and the other groove extends helically around the drum 35 from about 180° to about 360°. In an exemplary embodiment, the first groove 45 may extend helically around the drum 35 from greater or equal to 0° to less than 180°, and the second groove 47 may extend helically around the drum 35 from greater or equal to 180° to less than 360°.

Referring again to FIGS. 1-3, 3A and 6, the rotating drum collimator 10 may also include a front collimator 60 positioned on a side of the drum 35 opposite the rear collimator 25. It is understood that “front” and “rear” are merely used as a term to distinguish between the front collimator 60 and the rear collimator 25, and that “front” and “rear” do not limit the position and/or orientation of the front collimator 60, the rear collimator 25 or drum 35 to any particular position and/or orientation. The front collimator 60 includes an opening 62 aligned with an opening in the housing 31 (FIG. 6) enclosing the drum 35, and another opening 64 spaced away from the opening in the housing 31. The openings 62, 64 allow for the beam of energy that has passed through the iris 49 in the drum 35 to extend from the rotating drum collimator 10. The front collimator 60 may also include a plurality of fan shaped channels 66 that are configured to further collimate the beam of energy that passes through the drum 35. Each of the fan shaped channels 66 extends from the opening 62 adjacent to the drum 35 to the opening 64 at the other side of the front collimator 60. At least one of the fan shaped channels 66 may be positioned substantially normal to the opening 62 of the front collimator 60 adjacent to the drum 35, for example one or more of the fan shaped channels 66 positioned towards the center of the front collimator 60. The one or more fan shaped channels 66 positioned on either side of the normal fan shaped channel or channels 66 may then be positioned slightly askew relative to the normal fan shaped channel or channels 66 so that the fan shaped channels 66 on one side the normal fan shaped channel or channels 66 are diverging in one direction and the fan shaped channels on the other side are diverging in the other direction. In this manner, the front collimator 60 provides for transmission of the beam of energy along the degrees of an arc defined by the plurality of fan shaped channels 66. Each of the fan shaped channels 66 may have the same cross-sectional shape so that the beam of the energy passing through each fan shaped channel 66 has substantially the same shape when the beam of energy exits the opening 64 of the front collimator 60. Furthermore, each of the fan shaped channels 66 in the front collimator 60 may be narrower at the opening 62 positioned closer to the drum 35 then the opening 64 spaced from the drum 64. In this manner, the width of the beam of energy entering any particular fan shaped channel 66 may increase as the beam of energy travels farther from the drum 35.

It is understood that the energy generator 20, rear collimator 25, drum 35 and/or front collimator 60 may be made from any suitable material that is capable of providing shielding and/or absorption of the beam of energy that is generated from the energy source 22. It is understood what materials may be suitable for particular purposes. For example, the components of the rotating drum collimator 10 may be made from a material such as lead, tungsten or a tungsten alloy, or the like, if the beam of energy that is generated is an X-ray beam or other radiation beam. It is also understood that each of the components of the rotating drum collimator 10 may be made from a different material or the same material depending on the desired application, manufacture and/or purpose of the rotating drum collimator 10. It is understood that the material selected should be sufficient to allow for direction and/or control of the beam of energy that is generated, and therefore the materials selected may depend upon the type of energy beam generated.

Referring now to FIGS. 1-2, 3 and 3A, the operation and use of the rotating drum collimator 10 according to the present invention will now be discussed. As shown by FIGS. 1 and 3, the rotating drum collimator 10 allows for a scanning beam 100 to be produced as the result of rotation of the drum 35. For example, beam 100T¹ shows the position of an exemplary beam 100 generated by the rotating drum collimator 10 at Time 1. At Time 2, which may be some time after or before Time 1, beam 100T² represents the position of the exemplary beam 100 generated by the rotating drum collimator 10 as the drum 35 is rotated about its longitudinal axis 51 by the motor 37 and the iris 49 formed by intersection of the grooves 45, 47 moves along the longitudinal axis 51 of the drum 35. As the drum 35 further is rotated, beam 100T³ is produced and represents the position of the exemplary beam at Time 3, which may be some time after or before Time 2. The movement of the beam 100 between the positioned for beam 100T¹, beam 100T² and beam 100T³ produces a scanning beam that travels right-to-left and/or left-to-right along the opening 64 of the front collimator 60 so that the scanning beam has angular motion along the degrees of an arc.

It is understood as a result of the rotation of the drum 35, the beam generated by the rotating drum collimator forms a scanning beam as it moves from the position of beam 100T¹ to the position of beam 100T³ and/or the position of beam 100T³ to the position of beam 100T¹. As a result of the width of the grooves 45, 47 increasing from the middle portion 53 of the grooves 45, 47 towards the end portions 55, the beam of energy transmitted from the energy generator 20 may extend out along the degrees of an arc, and therefore the scanning beam produced by the rotating drum collimator 10 according to the present invention is not limited to one particular linear direction, but instead may extend outwardly at an angle from the drum 35 and/or front collimator 60 to allow for angular motion of the scanning beam. Furthermore, the plurality of fan shaped channels 33 formed in the rear collimator 25 and the plurality of fan shaped channels 66 formed in the front collimator 60 allow the beam of energy to have a consistent and/or uniform cross-section as the beam of energy travels between positions of beam 100T¹ and beam 100T³. Since the end portions 55 of the grooves 45, 47 of the drum 35 may be larger than the middle portion of the grooves 45, 47 additional energy may be passed through the drum/rotating slotted wheel that would result in the generation of a beam that has different and/or varying cross-sections and/or sizes as the beam 100 travels between positions of beam 100T¹ and beam 100T³. However, since the plurality of fan shaped channels 33 of the rear collimator 25 and the plurality of fan shaped channels 66 of the front collimator 60 are positioned in a fan-shaped pattern the angle of the fan shaped channels 33, 366 relative to the drum 35 block and/or absorb the additional portions of the beam of energy that do not fit through the plurality of fan shaped channels 33, 66 in order to define a consistent scanning beam 100.

Therefore, it is understood that as the drum 35 is rotated either clockwise or counter-clockwise, depending upon the desired directly of the scanning beam 100, the scanning beam 100 will travel in an angular direction along the degrees of the arc formed by the front collimator 60. The speed at which the drum 35 is rotated, which may be based upon the speed that the motor 37 is set to, will determine the scanning frequency of the scanning beam 100 produced by the rotating drum collimator 10. For example, as the revolutions of the drum 35 are increased, the scanning rate of the scanning beam 100 will increase thereby subjecting the object to be scanned to additional energy. It is understood that since the mass of the drum 35 may be kept low in accordance with the design of the present invention, the time required to either change the rotation speed of the drum 35 and/or change the direction of rotation of the drum 35 may be minimized compared to other devices that use a larger rotating mass in order to collimate energy. It may be desirable to position the rotating drum collimator 10 a suitable distance away from the object to be scanned in order to provide a continuous scanning beam, since it is understood that even with the plurality of fan shaped channels 66 formed in the front collimator 60, as the object to be scanned moves away from the rotating drum collimator 10 a continuous scanning beam will be formed due to the intersection of collimated beams as they move away from the front collimator 60.

The rotating drum collimator 10 may be used for a variety of applications, for example the rotating drum collimator 10 may be used as a back-scatter X-ray scanning device. However, it is understood that the rotating drum collimator 10 may be suitable for a variety of applications depending upon the energy being generated and the type of scanning beam being produced. For example, the rotating drum collimator 10 may be used for a variety of imaging applications, such as for medical, industrial and/or security purposes. The rotating drum collimator 10 may be used a stationary device, such as in use for medical imaging or at security checkpoints, such as those at airports, bridges and/or borders. Furthermore, it is understood that due to the reduction in size and materials required to produce the scanning beam by the rotating drum collimator 10 according to the present invention, the rotating drum collimator 10 may also be used in a portable applications, such as being fitting into a vehicle for security, whether military or non-military, or industrial purposes.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed is:

1. A rotating drum collimator, comprising:
a drum having a substantially cylindrical sidewall with a first helical groove and a second helical groove formed in the cylindrical side wall; and
a motor operatively connected to the drum, and configured to cause rotation of the drum about a longitudinal axis of the drum;
wherein each of the first helical groove and the second helical groove comprises a first end portion, a middle portion and a second end portion, and
wherein a width of the first end portion and the second end portion of each of the first helical groove and the second helical groove is greater than the middle portion of each of the first helical groove and the second helical groove.

2. The rotating drum collimator according to claim 1, further comprising a first collimator positioned adjacent to the drum, and a second collimator positioned on a side of the drum opposite the first collimator.

3. The rotating drum collimator according to claim 2, further comprising a drum assembly substantially enclosing the drum and connecting the first collimator to the second collimator.

4. The rotating drum collimator according to claim 2, wherein the first collimator comprises a first side and a second side, wherein the first side has a width smaller than the second side.

5. The rotating drum collimator according to claim 4, wherein the first collimator comprises a plurality of channels extending between the first side and the second side, and wherein each of the plurality of channels has substantially the same cross-sectional shape.

6. The rotating drum collimator according to claim 5, wherein the first side of the first collimator has a substantially arcuate configuration, and each of the plurality of channels is positioned substantially normal to the first side of the first collimator.

7. The rotating drum collimator according to claim 5, wherein each of the plurality of channels extending between the first side and the second side is smaller at the first side than at the second side of the first collimator.

8. The rotating drum collimator according to claim 2, wherein the second collimator comprises a first side and a second side, wherein the first side has a width smaller than the second side, and wherein the second collimator comprises a plurality of channels extending between the first side and the second side of the second collimator.

9. The rotating drum collimator according to claim 8, wherein the plurality of channels comprises a central channel positioned substantially normal to the first side of the second collimator, and at least one angled channel diverging away from the central channel in a direction towards the second side of the second collimator.

10. The rotating drum collimator according to claim 9, wherein the at least one angled channel comprises a first angled channel diverging in a first direction relative to the central channel, and a second angled channel diverging in a second direction opposite the first direction.

11. The rotating drum collimator according to claim 1, wherein the drum comprises a first end and a second end and the first helical groove extends from adjacent the first end at about 0° on the cylindrical sidewall to adjacent the second end at about 180° on the cylindrical sidewall.

12. The rotating drum collimator according to claim 11, wherein about 0° is greater or equal to 0° on the cylindrical sidewall, about 180° is less than 180° on the cylindrical sidewall.

13. The rotating drum collimator according to claim 11, wherein the second helical groove extends from adjacent the first end at about 180° on the cylindrical sidewall to adjacent the second end at about 360° on the cylindrical sidewall.

14. The rotating drum collimator according to claim 13, wherein about 180° is greater or equal to 180° on the cylindrical sidewall, about 360° is less than 360° on the cylindrical sidewall.

15. The rotating drum collimator according to claim 1, wherein the ratio of the width of the first helical groove at the middle portion to the width of the first helical groove at the end portions is 1:x, wherein x is greater than 1.

16. The rotating drum collimator according to claim 15, wherein the first helical groove and the second helical groove are substantially the same shape and size.

17. The rotating drum collimator according to claim 1, further comprising a housing for an energy source configured to direct a beam of energy from the energy source towards the drum.

18. The rotating drum collimator according to claim 17, wherein an iris is formed passing through the drum at a transversal of the first helical groove and the second helical groove substantially perpendicular to the cylindrical sidewall.

19. The rotating drum collimator according to claim 18, wherein the iris is configured to move along the longitudinal axis of the drum in a first direction when the drum is rotated in a first angular direction, and wherein the iris moves along the longitudinal axis of the drum in a second direction when the drum is rotated in a second angular direction opposite the first angular direction.

20. The rotating drum collimator according to claim 18, wherein the beam of energy is absorbed by the drum and passes through the iris formed in the drum from the transversal of the first helical groove and the second helical groove.
